(19) United States
(12) Patent Application Publication
(10) Pub. No.: US 2023/0281704 A1
(43) Pub. Date: Sep. 7, 2023

(54) VEHICLE AND METHOD OF GUIDING CONNECTED CAR SERVICE THEREOF

(71) Applicants: HYUNDAI MOTOR COMPANY, Seoul (KR); KIA CORPORATION, Seoul (KR)

(72) Inventor: Jaeyoon KO, Yongin-si, Gyeonggi-do (KR)

(73) Assignees: HYUNDAI MOTOR COMPANY, Seoul (KR); KIA CORPORATION, Seoul (KR)

(21) Appl. No.: 18/078,348

(22) Filed: Dec. 9, 2022

(30) Foreign Application Priority Data
Mar. 2, 2022 (KR) 10-2022-0026861

(51) Int. Cl. G06Q 30/0645; G06Q 50/30

(52) U.S. Cl. CPC G06Q 30/0645; G06Q 50/30

(57) ABSTRACT

A vehicle and a method of guiding a connected car service thereof that are capable of, when the user (the owner) of the vehicle is changed due to a used car transaction or transfer, etc., providing a new user (a new owner) with connected car service related information according to a current connected car service status of the vehicle, and proceeding with a succession procedure of the remaining usage authority of the connected car service according to the new user's (the new owner's) selection. To this end, the method of guiding a connected car service for a vehicle includes: receiving connected car service information about a connected car service of a vehicle; and guiding information related to a succession of connected car service use authority based on the connected car service information.

### CROSS-REFERENCE TO RELATED APPLICATION

This application is based on and claims priority under 35 U.S.C. § 119 to Korean Patent Application No. 10-2022-0026861, filed on Mar. 2, 2022 in the Korean Intellectual Property Office, the disclosure of which is incorporated herein by reference.

### BACKGROUND

### 1. Technical Field

The disclosure relates to a vehicle, and specifically, to a connected car service of a vehicle.

### 2. Description of the Related Art

A connected car service enables communication with other vehicles, transportation infrastructure, communication infrastructure, and mobile devices in real time, to support convenience and traffic safety of drivers while providing various Internet services. In addition, the connected car service enables communication with other vehicles to exchange collision warning signals or intersection control information. In addition, the connected car service provides traffic safety support, real-time route guide, and vehicle inspection services at traffic centers. The occupant may use a music and movie streaming service, a real-time weather and news search service, etc. by using Wi-Fi or using a mobile device of the vehicle as a hotspot. In addition, the connected car service provides services, such as e-mail, route guide, life information, theft detection, and voice memos.

### SUMMARY

The present disclosure may provide a vehicle and a method of guiding a connected car service thereof that are capable of, when a user (an owner) of the vehicle is changed due to a used car transaction or transfer, etc., providing a new user (a new owner) with connected car service related information according to a current state of the connected car service of the vehicle, and proceeding with a succession procedure of the remaining usage authority of the connected car service according to the new user's (the new owner's) selection.

The technical objectives of the disclosure are not limited to the above, and other objectives may become apparent to those of ordinary skill in the art based on the following descriptions.

According to an aspect of the disclosure, there is provided a method of guiding a connected car service for a vehicle, the method including: receiving, by a controller, connected car service information of the vehicle; and guiding, by the controller, information related to a succession of connected car service usage authority based on the connected car service information.

In a state in which the connected car service usage authority of the vehicle is revoked, the connected car service information may include, information related to at least one of: a subscription rate plan and whether to be a subject of the succession of the connected car service usage authority of the vehicle at a time of the revocation; a validity of a remaining service period of the connected car service usage authority of the vehicle at a time of the revocation; and a rate plan succession type.

The subscription rate plan may include a free plan and a paid plan.

The connected car service usage authority of the vehicle is not a subject of succession or the remaining service period expires and is invalid, and the guiding of the information related to the succession may include guiding, by the controller, subscription of the paid plan for the connected car service.

The connected car service usage authority of the vehicle is a subject of succession and the remaining service period is valid, the guiding of the information related to the succession of the connected car service usage authority may include guiding, by the controller, the succession of the connected car service usage authority of the vehicle, and the connected car service usage authority of the vehicle may be available for a free plan.

The information related to the succession may include at least one of: whether succession of the connected car service is allowable; a procedure to subscribe to the connected car service; or an expiration date of the connected car service.

The method may further include providing, by the controller, the connected car service without guiding the information related to the succession, where the connected car service of the vehicle is in an opened state.

The method may further include providing, by the controller, subscription information of the connected car service without guiding the information related to the succession, where the connected car service of the vehicle is in an non-opened state.

According to an aspect of the disclosure, there is provided a vehicle including: a communicator configured to communicate with a connected car server; and a controller configured to receive connected car service information about a connected car service of the vehicle from the connected car server and guide information related to a succession of connected car service usage authority based on the connected car service information.

In a state in which the connected car service usage authority of the vehicle is revoked, the connected car service information may include information related to at least one of: a subscription rate plan and whether to be a subject of the succession of the connected car service usage authority of the vehicle at a time of the revocation; a validity of a remaining service period of the connected car service usage authority of the vehicle at a time of the revocation; and a rate plan succession type.

The subscription rate plan may include a free plan and a paid plan.

The connected car service usage authority of the vehicle is not a subject of succession or the remaining service period is invalid due to expiration, and the guiding of the information related to the succession may include guiding subscription of the paid plan for the connected car service.

The connected car service usage authority of the vehicle is a subject of succession and the remaining service period is valid, the guiding of the information related to the succession may include guiding the succession of the connected car service usage authority of the vehicle, and the connected car service usage authority of the vehicle may be available for a free plan.

The information related to the succession may include at least one of: whether succession of the connected car service is allowable; a procedure to subscribe to the connected car service; or an expiration date of the connected car service.

The controller may be further configured to provide the connected car service without guiding the information related to the succession, and the connected car service of the vehicle is in an opened state.

The controller may be further configured to provide subscription information of the connected car service without guiding the information related to the succession, and the connected car service of the vehicle is in an non-opened state.

According to an aspect of the disclosure, there is provided a method of guiding a connected car service for a vehicle, the method including: receiving, by a controller, connected car service information including information related to at least one of, a subscription rate plan and whether to be a subject of succession of a connected car service usage authority of the vehicle, a validity of a remaining service period of the connected car service usage authority of the vehicle, and a rate plan succession type, and storing, by the controller, the received connected car service information; identifying whether the connected car service of the vehicle is revoked based on the connected car service information whenever a connected car terminal is booted; and in response to identifying that the connected car service of the vehicle is in a revoked state, the connected car service usage authority of the vehicle is available for a free plan at a time of the revocation, a service period is valid, and succession of a rate plan is allowable, providing, by the controller, information related to a free succession of the connected car service usage authority.

The method may further include guiding, by the controller, subscription of a paid plan for the connected car service, where the connected car service usage authority of the vehicle is not a subject of the succession or the remaining service period expires and is invalid.

The information related to the succession may include at least one of: whether succession of the connected car service is allowable; a procedure to subscribe to the connected car service; or an expiration date of the connected car service.

The method may further include providing, by the controller, subscription information of the connected car service without guiding the information related to the succession, where the connected car service of the vehicle is in a non-opened state.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating a connected car system for a vehicle according to an embodiment of the disclosure;

FIG. 2 is a diagram illustrating a control system of a connected car system according to an embodiment of the disclosure;

FIG. 3 is a diagram illustrating a method of guiding a connected car service for a vehicle according to an embodiment of the disclosure; and

FIG. 4 is a table illustrating CASE 1 to CASE 6 of the method of guiding the connected car service of the vehicle shown in FIG. 3.

### DETAILED DESCRIPTION

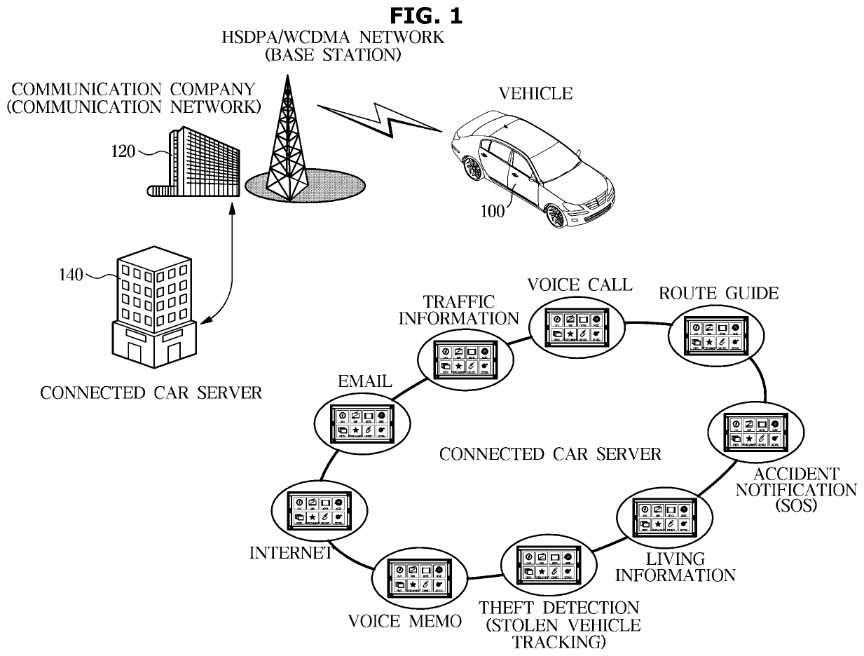

FIG. 1 is a diagram illustrating a connected car system for a vehicle according to an embodiment of the disclosure.

Referring to FIG. 1, a vehicle 100 may communicate with a connected car server 140 through a communication network of a communication company 120 to use a connected car service provided from the connected car server 140.

The connected car service enables communication with other vehicles, transportation infrastructure, communication infrastructure, and mobile devices in real time, to support convenience and traffic safety of drivers while providing various Internet services. In addition, the connected car service enables communication with other vehicles to exchange collision warning signals or intersection control information. In addition, the connected car service provides traffic safety support, real-time route guide, and vehicle inspection services at traffic centers. The occupant may use a music and movie streaming service, a real-time weather and news search service, etc. by using Wi-Fi or using a mobile device of the vehicle as a hotspot. In addition, the connected car service provides services such as e-mail, route guide, life information, theft detection, and voice memos.

Such a connected car service includes a paid service and a free service, and in case of mid-term revocation, the remaining usage authority may be transferred to another user. In an embodiment of the disclosure, when a user (an owner) of the vehicle 100 is changed due to, for example, used car transaction or transfer, connected car service related information is guided to a new user (a new owner) according to the current state of the connected car service of the vehicle 100, and a succession procedure of the remaining usage authority of the connected car service is performed according to the selection of the new user (the new owner).

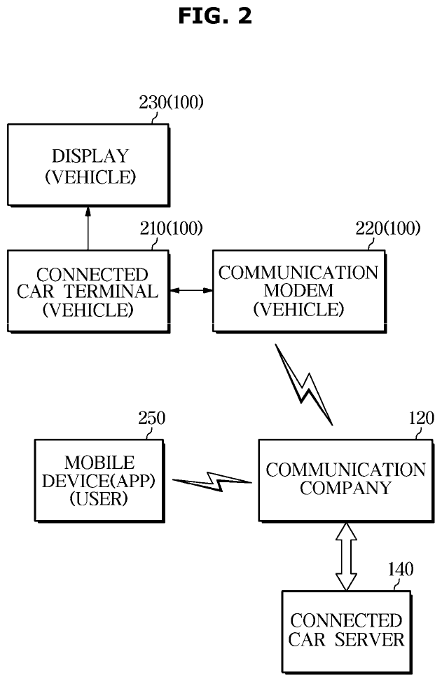

FIG. 2 is a diagram illustrating a control system of a connected car system according to an embodiment of the disclosure.

In FIG. 2, a connected car terminal 210 (controller) and a communication modem 220 (communicator) are devices mounted on the vehicle 100. A mobile device 250 is a communication device (e.g., a mobile phone) carried by a user (a passenger).

The communication company 120 provides a wireless communication network so that the vehicles 100 subscribed to a connected car service communicates with the connected car server 140. The connected car server 140 provides various types of connected car services to the vehicle 100 which is a subscriber to the connected car service.

The mobile device 250 may have an app installed thereon, for subscribing to/accessing a connected car service. A user (a passenger) may subscribe to a connected car service through the app installed in the mobile device 250. In addition, the user (the passenger) who has already subscribed to the connected car service may log in to the connected car service through the app installed in the mobile device 250 to use the corresponding service.

The connected car terminal 210 (controller) receives connected car service related information of the corresponding vehicle 100 from the connected car server 140 and stores the received connected car service related information, and displays connected car service related guide through a display 230 to allow the user (the passenger) to check the connected car service related information of the corresponding vehicle 100.

The connected car terminal 210 may be provided with a memory (not shown) for storing connected car service related information. The connected car terminal 210 may be implemented in the form of hardware, software, or a combination of hardware and software, or may be implemented as microprocessor, and may be, e.g., an electronic control unit (ECU), a micro controller unit (MCU), or other subcontrollers mounted in the vehicle.

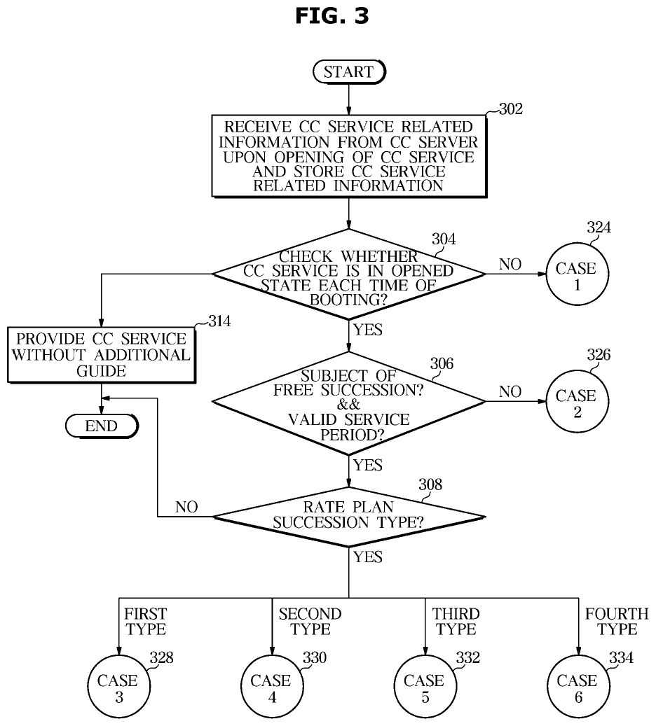

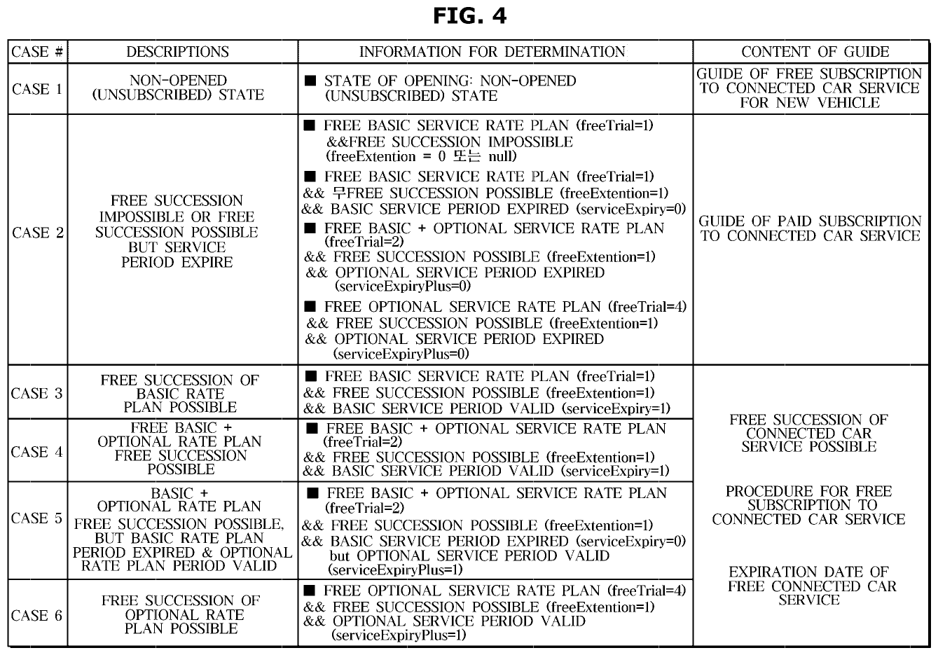

FIG. 3 is a diagram illustrating a method of guiding a connected car service for a vehicle according to an embodiment of the disclosure. The method of guiding the connected car service of the vehicle shown in FIG. 3 is implemented, when a user (an owner) of a vehicle is changed due to a used car transaction or transfer, etc., to provide a new user (a new owner) with connected car service related information according to a current state of a connected car service of the vehicle, and proceed with a succession procedure of the remaining usage authority of the connected car service according to the new user's (the new owner's) selection. FIG. 4 is a table illustrating CASE 1 to CASE 6 of the method of guiding the connected car service of the vehicle shown in FIG. 3.

Referring to FIG. 3, when the vehicle 100 first subscribes to a connected car service and opens the connected car service, the connected car terminal 210 receives connected car service related information from the connected car server 140 through the communication modem 220 and stores the connected car service related information in a memory (302). Here, the connected car service related information stored in the memory of the connected car terminal 210 includes information related to ‘subscription rate plan’, ‘whether to be a subject of free succession’, ‘basic service expiration date’, and ‘rate plan succession type’ of the connected car service.

In such a state in which the connected car service related information is stored in the memory, the connected car terminal 210 identifies a state of opening of the connected car service of the corresponding vehicle 100 every time the connected car terminal 210 is booted (304). The state of opening of the connected car service may include an ‘opened state’, an ‘unopened state’, and a ‘revocation state’.

The ‘opened state’ is a state in which the vehicle 100 is already subscribed to a connected car service and the service period has not expired, so the connected car service is still valid. If identified in operation 304 that the connected car service of the vehicle 100 is in an opened state, the connected car terminal 210 may immediately provide the connected car service without separate guidance (314).

The ‘unopened state’ is a state in which the vehicle 100 is not subscribed to a connected car service. If identified in operation 304 that the connected car service of the vehicle 100 is in a unopened state, the connected car terminal 210 proceeds to CASE 1 and displays, through the display 230, a free subscription guide for the connected car service. A new user (a new owner) of the vehicle 100 may proceed with free subscription of the connected car service by referring to the free subscription guide displayed on the display 230.

The ‘revocation state’ is a state in which the corresponding vehicle 100 has subscribed to the connected service but the subscription is currently canceled. In this case, depending on the combination of whether to be a subject of succession and a validity of a remaining service period of the connected car service use authority of the vehicle 100 (306) and a rate plan succession type (308), the connected car service related information is guided in several different forms (324 to 334).

That is, if identified in operation 304 that the connected car service usage authority of the vehicle 100 is currently in a ‘revocation state’, the connected car terminal 210 identifies whether the connected car service usage authority is a subject to succession and whether the basic service period is still valid (306). To this end, the connected car terminal 210 of the vehicle 100 according to the disclosure determines whether free succession is possible and whether the service period has expired based on the contents described in ‘information for determination’ of CASE 2 in FIG. 3. (326) and FIG. 4. That is, the connected car terminal 210 may, if the rate plan is a free basic service rate plan but free succession is impossible, determine that free succession of the current connected car service of the corresponding connected car terminal 210 is impossible. In addition, the connected car terminal 210 may, if the rate plan is a free basic service rate plan and free succession is possible, but the basic service period expires, determine that free succession of the current connected car service of the connected car terminal 210 is impossible. In addition, the connected car terminal 210 may, if the rate plan is a free basic+optional service rate plan, and free succession is possible, but the optional service period expires, determine that free succession of the current connected car service of the connected car terminal 210 is not possible. In addition, the connected car terminal 210 may, if the rate plan is a free optional service plan and free succession is possible, but the free optional service period expires, determine that free succession of the current connected car service of the connected car terminal 210 is impossible.

Referring again to FIG. 3, the connected car terminal 210 may, if the current connected car service usage authority of the vehicle 100 is not a subject of free succession or the basic service period expires and is invalid (NO in operation 306), proceed to CASE 2 and display, through the display 230, a paid subscription guide for the connected car service. A new user (a new owner) of the vehicle 100 may proceed with a paid subscription of the connected car service by referring to the paid subscription guide displayed on the display 230.

If the current connected car service usage authority of the vehicle 100 is a subject of free succession and the basic service period is still valid (YES in operation 306), the connected car terminal 210 identifies whether the current connected car service usage authority is a subject of rate plan succession (308). In the vehicle 100 according to the embodiment of the disclosure, various rate plan succession types are divided into CASE 3 to CASE 6 in FIGS. 3 and 4, and information for the rate plan succession types are displayed through the display 230. A new user (a new owner) of the vehicle 100 may determine whether to subscribe to the rate plan of the connected car service by referring to the rate plan succession guide displayed on the display 230 and when needed, proceed with the procedure for rate plan succession. CASE 3 to CASE 6 of the method of guiding a connected car service of a vehicle according to an embodiment of the disclosure will be described in detail with reference to FIG. 4 as follows.

Referring to FIG. 4, CASE 3 according to the rate plan succession type is a case in which free succession of the basic service rate plan of the connected car service is possible. The connected car terminal 210 may, if the current connected car service of the vehicle 100 is available for a free basic service rate plan, free succession is possible, and the basic service period has not expired and is valid, identify that free succession of the basic service rate plan is possible. In this regard, the connected car terminal 210 displays, on the display 230, information indicating that free succession of the connected car service for used cars is possible, the procedure for subscribing to a free connected car service, and the expiration date of the free connected car service. According to the display, the new owner of the vehicle 100 may determine whether to subscribe to the connected car service free of charge, and, when needed, proceed with the procedure for the free succession of the connected car service.

Referring to FIG. 4, CASE 4 according to the rate plan succession type is a case in which free succession of the basic service rate plan and the optional service rate plan of the connected car service is possible. The connected car terminal 210 may, if the current connected car service of the vehicle 100 is available for a free basic+optional service rate plan, free succession is possible, and the basic service period has not expired and is valid, identify that free succession of the basic service rate plan and the optional service rate plan is possible. In this regard, the connected car terminal 210 displays, on the display 230, information indicating that free succession of the connected car service for used cars is possible, the procedure for subscribing to the free connected car service, and the expiration date of the free connected car service. According to the display, the new owner of the vehicle 100 may determine whether to subscribe to the connected car service free of charge and, when needed, proceed with the procedure for the free succession of the connected car service.

Referring to FIG. 4, CASE 5 according to the rate plan succession type is a case in which free succession of the basic service rate plan and the optional service rate plan of the connected car service is possible, but the period of the basic service rate plan has expired and the period of the optional service rate plan still remains and is valid. The connected car terminal 210 may, if the current connected car service of the vehicle 100 is available for a free basic+optional service rate plan, free succession is possible, the basic service period has expired and thus is not valid, and only the optional service period is valid, determine that free succession of the basic service rate plan and the optional service rate plan is possible, but the period of the basic service rate plan has expired and the period of the optional service rate plan still remains and is valid. In this regard, the connected car terminal 210 displays, on the display 230, information indicating that free succession of the connected car service for used cars is possible, the expiration of the basic service rate plan, the validity of the optional service rate plan, the procedure for subscribing to the free connected car service, and the expiration date of the free connected car service. According to the display, the new owner of the vehicle 100 may determine whether to subscribe to the connected car service free of charge, and, when needed, proceed with the procedure for the free succession of the connected car service.

Referring to FIG. 4, CASE 6 according to the rate plan succession type is a case in which free succession of the optional service rate plan of the connected car service is possible. The connected car terminal 210 may, if the current connected car service of the vehicle 100 is available for a free optional service rate plan, free succession is possible, and the optional service period has not expired and thus is valid, determine that free succession of the optional service rate plan is possible. In this regard, the connected car terminal 210 displays, on the display 230, information indicating that free succession of the connected car service for used cars is possible, the procedure for subscribing to the free connected car service, and the expiration date of the free connected car service. According to the display, the new owner of the vehicle 100 may determine whether to subscribe to the connected car service free of charge, and when needed, proceed with the procedure for the free succession of the connected car service.

As is apparent from the above, the vehicle and the method of guiding a connected car service thereof can, when a user (an owner) of the vehicle is changed due to a used car transaction or transfer, etc., provide a new user (a new owner) with connected car service related information according to a current state of the connected car service of the vehicle, and proceed with a succession procedure of the remaining usage authority of the connected car service according to the new user's (the new owner's) selection.

The above description of the present disclosure is for illustrative purposes, and a person having ordinary skilled in the art should appreciate that other specific modifications may be easily made without departing from the technical spirit or essential features of the present disclosure. Therefore, the above embodiments should be regarded as illustrative rather than limitative in all aspects. The scope of the disclosure is not to be limited by the detailed description set forth above, but by the accompanying claims of the present disclosure, and it should also be understood that all changes or modifications derived from the definitions and scope of the claims and their equivalents fall within the scope of the present disclosure.

What is claimed is:

1. A method of guiding a connected car service for a vehicle, the method comprising:
receiving, by a controller, connected car service information of the vehicle; and
guiding, by the controller, information related to a succession of connected car service usage authority based on the connected car service information.

2. The method of claim 1, wherein, in a state in which the connected car service usage authority of the vehicle is revoked, the connected car service information includes information related to at least one of: a subscription rate plan and whether to be a subject of the succession of the connected car service usage authority of the vehicle at a time of the revocation; a validity of a remaining service period of the connected car service usage authority of the vehicle at a time of the revocation; and a rate plan succession type.

3. The method of claim 2, wherein the subscription rate plan includes a free plan and a paid plan.

4. The method of claim 3, wherein the connected car service usage authority of the vehicle is not a subject of the succession or the remaining service period expires and is invalid, and the guiding of the information related to the succession includes guiding, by the controller, subscription of the paid plan for the connected car service.

5. The method of claim 3, wherein the connected car service usage authority of the vehicle is a subject of the succession and the remaining service period is valid, the guiding of the information related to the succession of the connected car service usage authority includes guiding, by the controller, the succession of the connected car service usage authority of the vehicle, and the connected car service usage authority of the vehicle is available for the free plan.

6. The method of claim 1, wherein the information related to the succession includes at least one of:
whether succession of the connected car service is allowable;
a procedure to subscribe to the connected car service; or
an expiration date of the connected car service.

7. The method of claim 1, further comprising providing, by the controller, the connected car service without guiding the information related to the succession, wherein the connected car service of the vehicle is in an opened state.

8. The method of claim 1, further comprising providing, by the controller, subscription information of the connected car service without guiding the information related to the succession, wherein the connected car service of the vehicle is in an non-opened state.

9. A vehicle comprising:
a communicator configured to communicate with a connected car server; and
a controller configured to: receive connected car service information about a connected car service of the vehicle from the connected car server; and
guide information related to a succession of connected car service usage authority based on the connected car service information.

10. The vehicle of claim 9, wherein, in a state in which the connected car service usage authority of the vehicle is revoked, the connected car service information includes information related to at least one of:
a subscription rate plan and whether to be a subject of the succession of the connected car service usage authority of the vehicle at a time of the revocation; a validity of a remaining service period of the connected car service usage authority of the vehicle at a time of the revocation; and a rate plan succession type.

11. The vehicle of claim 10, wherein the subscription rate plan includes a free plan and a paid plan.

12. The vehicle of claim 11, wherein the connected car service usage authority of the vehicle is not a subject of the succession or the remaining service period is invalid due to expiration, and the guiding of the information related to the succession includes guiding subscription of the paid plan for the connected car service.

13. The vehicle of claim 11, wherein the connected car service usage authority of the vehicle is a subject of the succession and the remaining service period is valid, the guiding of the information related to the succession includes guiding the succession of the connected car service usage authority of the vehicle, and
the connected car service usage authority of the vehicle is available for a free plan.

14. The vehicle of claim 9, wherein the information related to the succession includes at least one of:
whether succession of the connected car service is allowable;
a procedure to subscribe to the connected car service; or
an expiration date of the connected car service.

15. The vehicle of claim 9, wherein the controller is further configured to provide the connected car service without guiding the information related to the succession, and the connected car service of the vehicle is in an opened state.

16. The vehicle of claim 9, wherein the controller is further configured to provide subscription information of the connected car service without guiding the information related to the succession, and the connected car service of the vehicle is in an non-opened state.

17. A method of guiding a connected car service for a vehicle, the method comprising:
receiving, by a controller, connected car service information including information related to at least one of, a subscription rate plan and whether to be a subject of succession of a connected car service usage authority of the vehicle, a validity of a remaining service period of the connected car service usage authority of the vehicle, and a rate plan succession type, and storing, by the controller, the received connected car service information;
identifying, by the controller, whether the connected car service of the vehicle is revoked based on the connected car service information whenever a connected car terminal is booted; and
in response to identifying that the connected car service of the vehicle is in a revoked state, the connected car service usage authority of the vehicle is available for a free plan at a time of the revocation, a service period is valid, and succession of a rate plan is allowable, providing, by the controller, information related to a free succession of the connected car service usage authority.

18. The method of claim 17, further comprising guiding, by the controller, subscription of a paid plan for the connected car service, wherein the connected car service usage authority of the vehicle is not a subject of the succession or the remaining service period expires and is invalid.

19. The method of claim 17, wherein the information related to the succession includes at least one of:
whether succession of the connected car service is allowable;
a procedure to subscribe to the connected car service; or
an expiration date of the connected car service.

20. The method of claim 17, further comprising providing, by the controller, subscription information of the connected car service without guiding the information related to the succession, wherein the connected car service of the vehicle is in a non-opened state.
